(19) United States
(12) Patent Application Publication
(10) Pub. No.: US 2011/0298836 A1
(43) Pub. Date: Dec. 8, 2011

(54) ORGANIC LIGHT EMITTING DIODE DISPLAY AND DRIVING METHOD THEREOF

(75) Inventors: Naoaki Komiya, Yongin-city (KR); Choon-Yul Oh, Yongin-city (KR); Ho-Ryun Chung, Yongin-city (KR); Myoung-Hwan Yoo, Yongin-city (KR); Joo-Hyeon Jeong, Yongin-city (KR); Wang-Jo Lee, Yongin-city (KR); In-Ho Choi, Yongin-city (KR); Chang-Ho Hyun, Yongin-city (KR); Woung Kim, Yongin-city (KR)

(73) Assignee: Samsung Mobile Display Co., Ltd., Yongin-city (KR)

(21) Appl. No.: 13/013,719

(22) Filed: Jan. 25, 2011

(30) Foreign Application Priority Data
Jun. 4, 2010 (KR) 10-2010-0052924

(51) Int. Cl. G09G 5/10; G09G 3/30

(52) U.S. Cl. 345/690; 345/77

(57) ABSTRACT

An organic light emitting diode display is disclosed. A signal from the pixels in the display is transmitted to a circuit which compensates the image data according to the signal, which is indicative of one or more of ageing of the organic light emitting diodes, the threshold voltages of the driving transistors, and current mobility of the driving transistors.

### CROSS-REFERENCE TO RELATED APPLICATIONS

This application claims priority to and the benefit of Korean Patent Application No. 10-2010-0052924 filed in the Korean Intellectual Property Office on Jun. 4, 2010, the entire contents of which are incorporated herein by reference.

### BACKGROUND

1. Field

The disclosed technology relates to an organic light emitting diode display and a driving method thereof, and more particularly, to an organic light emitting diode display capable of suppressing an image sticking phenomenon and reduced lifespan due to ageing of an organic light emitting diode and a driving method thereof.

2. Description of the Related Technology

Recently, various flat panel displays having reduced weight and volume compared to cathode ray tubes have been developed. The flat panel displays include liquid crystal displays (LCD), field emission displays (FED), plasma display panels (PDP), and organic light emitting diode (OLED) displays, or the like.

The organic light emitting diode display, which displays images by using an array of organic light emitting diodes (OLED) that generate light by recombining electrons and holes, has a fast response speed, is driven with low power consumption, and has excellent emission efficiency, luminance, and viewing angle.

Generally, an organic light emitting diode display is either a passive matrix type organic light emitting diode (PMOLED) display or an active matrix type organic light emitting diode (AMOLED) display, according to the driving scheme.

The passive matrix type of display uses a scheme that has a positive electrode and a negative electrode orthogonal to each other. a negative line and a positive line are selected and driven according to image data. The active matrix type of display uses a driving scheme that integrates a thin film transistor and a capacitor in each pixel to store a voltage with the capacitor.

The passive matrix type of display has a simple structure and is inexpensive. However, it is difficult to implement a large or high precision panel with such technology. On the other hand, the active matrix type can be used to implement a large and high precision panel. However, it is difficult to implement the requisite controlling circuitry and it is expensive.

The active matrix type organic light emitting diode (AMOLED) display, which selects and turns-on each unit pixel, has been mainly used because of its superior performance regarding resolution, contrast, operational speed, etc.

Each pixel of the active matrix type OLED (hereinafter, referred to as an organic light emitting diode display) includes an organic light emitting diode, a driving transistor that controls an amount of current supplied to the organic light emitting diode, and a switching transistor that transfers data signals to control the driving transistor.

Among a large group of pixels, deviation of threshold voltage and current mobility between the driving transistors occurs. These deviations may occur during the manufacturing process of the driving transistor and/or may occur due to ageing of the driving transistor according to the amount of use of the organic light emitting diode display. The deviations degrade the image quality of the organic light emitting diode display.

Further, when the organic light emitting diode deteriorates due to ageing, the emission efficiency of the organic light emitting diode is reduced. When this happens, the amount of current that causes the organic light emitting diode to emit light with the same luminance increases.

Image sticking may also occur due to the variation of the ageing among the plurality of organic light emitting diodes. Image sticking, also called image retention or ghosting, is a phenomenon whereby a faint outline of a previously displayed image remains visible when a new image is displayed.

Further, a voltage drop may occur in wiring supplying the driving voltage to the plurality of pixels of the organic light emitting diode display in the large display panel. Image quality may also be reduced due to this effect.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One inventive aspect is an organic light emitting diode display. The display includes a display unit including a plurality of pixels, each pixel including a driving transistor and an organic light emitting diode. The display also includes a data driver configured to transmit compensated data signals to each of the pixels, a scan driver configured to transmit scan signals to each of the pixels, a sensing driver configured to transmit sensing signals to each of the plurality of pixels, a light emitting control driver configured to transmit light emitting control signals to each of the pixels, and a compensator configured to determine data signal compensation for the data signals. In response to receiving a sensing signal during a sensing period of a frame, a group of pixels are configured to transmit from each pixel a signal, where the signal is indicative of one or more of ageing of the organic light emitting diode of the pixel, the threshold voltage of the driving transistor of the pixel, and current mobility of the driving transistor of the pixel. During a data writing period of the frame, the plurality of pixels are configured to store image data compensated based on the signal transmitted from the pixels, and during a light emitting period of the frame, in response to the light emitting control signals, the pixels are configured to emit light based on the compensated image data.

Another inventive aspect includes a method of driving an organic light emitting diode display. The display includes a display unit having a plurality of pixels, a data driver configured to transfer data signals to each of the pixels, a scan driver configured to transfer scan signals to each of the pixels, a sensing driver configured to transfer sensing signals to each of the pixels, a light emitting control driver configured to transfer light emitting control signals to each of the pixels, and a compensator configured to determine data signal compensation for image signals transferred to each of the pixels. The method includes sensing a degree of ageing of the organic light emitting diode of each of the pixels of a group of pixels or sensing deviation of a driving transistor of each pixel of the group, writing compensated data according to a data signal compensated based on the degree of ageing of the organic light emitting diode or the deviation of the driving transistor, and simultaneously emitting light from the pixels according to the compensated data.

### BRIEF DESCRIPTION OF THE DRAWINGS

FIG. 1 is a block diagram showing an organic light emitting diode display according to an exemplary embodiment;

FIG. 2 is a circuit diagram showing a circuit configuration of an exemplary embodiment of a pixel shown in FIG. 1;

FIG. 3 is a diagram illustrating functionality for driving a pixel of the organic light emitting diode display according to an exemplary embodiment;

FIG. 4 is a timing diagram showing a method of driving the pixel of the organic light emitting diode display according to an exemplary embodiment;

FIG. 5 is a diagram illustrating functionality for driving a pixel of the organic light emitting diode display according to another exemplary embodiment; and

FIG. 6 is a timing diagram showing for a method of driving the pixel of the organic light emitting diode display according to another exemplary embodiment

### DETAILED DESCRIPTION OF CERTAIN INVENTIVE EMBODIMENTS

Various inventive aspects are described more fully hereinafter with reference to the accompanying drawings, in which exemplary embodiments are shown. As those skilled in the art realize, the described exemplary embodiments may be modified in various ways, without departing from the spirit or scope of the present invention.

Further, like reference numerals generally denote like components throughout the exemplary embodiments. A first exemplary embodiment will be representatively described and therefore, components other than those of the first exemplary embodiment will be emphasized in other exemplary embodiments.

The drawings and description are to be regarded as illustrative in nature and not restrictive. Like reference numerals generally designate like elements throughout the specification.

In the specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

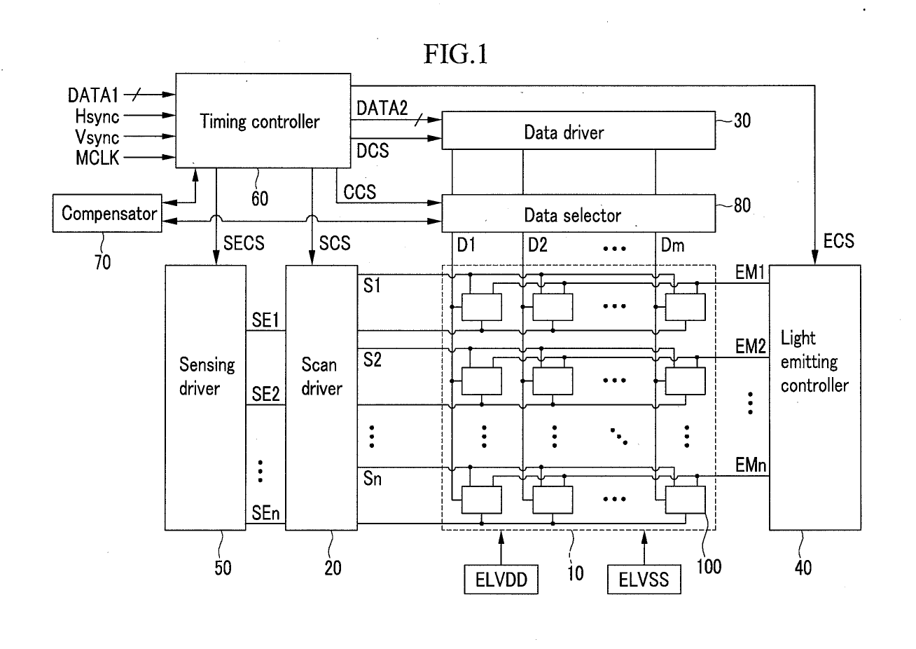

FIG. 1 is a block diagram showing an organic light emitting diode display according to an exemplary embodiment Referring to FIG. 1, an organic light emitting diode display includes a plurality of pixels 100 that are positioned in a predetermined area of a display unit 10 where a plurality of scan lines S1 to Sn, a plurality of light emitting control lines EM1 to EMn, a plurality of sensing lines SE1 to SEn, a plurality of data lines D1 to Dm intersect one another. The pixels are connected to the corresponding scan lines, light emitting control lines, sensing lines, and data lines.

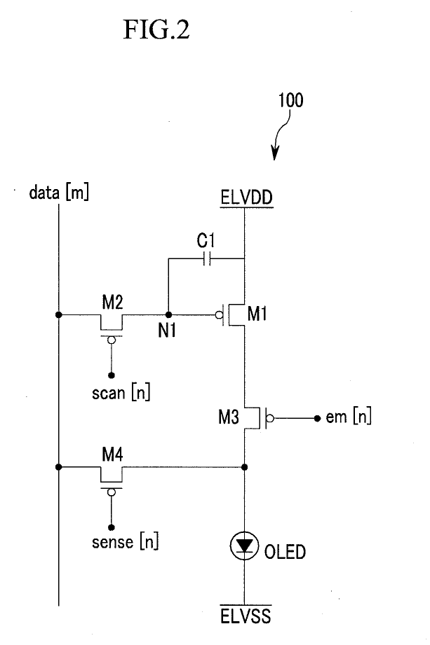

A circuit diagram of a configuration of an embodiment of the pixel 100 is described with reference to FIG. 2.

In the exemplary embodiment of FIG. 1, the organic light emitting diode display includes a display unit 10, a scan driver 20, a sensing driver 50, a light emitting driver 40, a data driver 30, a data selector 80, and a compensator 70. Further, the organic light emitting diode display includes a timing controller 60, which generates and transfers control signals to control the scan driver 20, the sensing driver 50, the light emitting driver 40, the data driver 30, the data selector 80, and the compensator 70.

The timing controller 60 receives a RGB image signal DATA1 that includes gray scale data regarding red, green, and blue data generates the compensated image data signal DATA2 using data signal compensation information transmitted from the compensator 70, and transfers the compensated image data signal DATA2 to the data driver 30. The data signal compensation is described with reference to the compensator 70.

The timing controller 60 generates the driving control signals for driving the scan driver 20, the data driver 30, the light emitting control driver 40, the sensing driver 50, and the data selector 80 with a horizontal synchronization signal Hsync, a vertical synchronization signal Vsync, and a clock signal MCLK that are external inputs. In other words, a data driving control signal DCS generated from the timing controller 60 is supplied to the data driver 30, a scan driving control signal SCS is supplied to the scan driver 20, and a sensing driving control signal SECS is supplied to the sensing driver 50.

The timing controller 60 supplies a light emitting driving control signal ECS to the light emitting control driver 40. Further, the timing controller 50 supplies a selection compensation control signal CCS to the data selector 80.

The scan driver 20 generates a plurality of scan signals according to the scan driving control signal SCS and transfers them to the plurality of scan lines S1 to Sn. Further, the scan driver 20 transfers the scan signals corresponding to each of the plurality of scan lines S1 to Sn. As a result, the plurality of pixels included in the display unit 10 are sequentially selected line by line.

The sensing driver 50 generates a plurality of sensing signals according to the sensing driving control signal SECS and transfers them to the plurality of sensing lines SE1 to SEn.

The sensing driver 50 transfers the sensing signals corresponding to each of the plurality of sensing lines SE1 to SEn. The light emitting control driver 40 generates the plurality of light emitting control signals according to the light emitting driving control signal ECS and supplies them to the plurality of light emitting control lines EM1 to EMn.

The light emitting control driver 40 transfers the light emitting control signals corresponding to each of the plurality of light emitting control lines EM1 to EMn.

The data driver 30 generates a plurality of data signals according to the compensated image data signal DATA2 and the data driving control signal DCS and transfers the data signals to the plurality of data lines D1 to Dm. The data signals are synchronized with each other and with the scan signals transferred to the corresponding scan lines.

The data selector 80 includes a plurality of first selection switches (not shown) that are connected between the data driver 30 and each of the plurality of data lines D1 to Dm and a plurality of second selection switches (not shown) that are connected between the compensator 70 and each of the plurality of data lines D1 to Dm. The data selector 80 switches the plurality of first and second selection switches according to the selection compensation control signal CCS.

The plurality of first selection switches connect or disconnect the plurality of data lines D1 to Dm to and from the data driver 30. When the data lines D1 to Dm are connected to the data driver 30 by the first selection switches, the data signals generated from the data driver 30 are transferred to the data lines. The second selection switches connect or disconnect the data lines D1 to Dm to and from the compensator 70.

When the compensator 70 is connected to one of the data lines, the data compensation information supplied through the connected data line is transferred to the compensator 70. The data compensation information supplied through the data line may be information regarding the gate electrode voltage of the driving transistor that can indicate the driving voltage of the organic light emitting diode and the threshold voltage and current mobility of the driving transistor to represent the degree of ageing of the organic light emitting diode of each of the plurality of pixels connected to the data lines.

In the organic light emitting diode display according to an exemplary embodiment, the compensator 70 receives the data compensation information on each of the plurality of pixels 100 during a sensing period. The compensator 70 determines the data voltage compensation so that the organic light emitting diodes of each of the plurality of pixels can emit light at the targeted luminance according to the data signal despite deterioration. The data voltage compensation is determined according to the ageing of the organic light emitting diode or the threshold voltage and the deviation of the mobility of the driving transistor.

For example, when the organic light emitting diode has deteriorated, the emission efficiency is reduced, such that even though the same current is supplied to the organic light emitting diode, the light emission thereof is reduced compared to when the organic light emitting diode was not deteriorated.

The data voltage compensation according to the exemplary embodiment includes compensation for the reduction in light emission.

The compensator 70 may store the data voltage compensation in a lookup table and may include a memory unit including the lookup table. The data voltage compensation information is transferred from the compensator 70 to the timing controller 60 and the timing controller 60 compensates the image data signal according to the transferred compensation information.

The display unit 10 of the organic light emitting diode display according to the exemplary embodiment receives a first power supply voltage ELVDD and a second power supply voltage ELVSS, which are used to supply driving current to each of the plurality of pixels, from the a power supply unit (not shown).

FIG. 2 is a circuit diagram showing a circuit configuration of an exemplary embodiment of the pixel 100 shown in FIG. 1. Referring to FIG. 2, the pixel 100 of the display unit 10 according to the exemplary embodiment indicates a pixel included in an n-th pixel row among a plurality of pixel rows and corresponding to an m-th pixel column.

The pixel 100 includes an organic light emitting diode (OLED) and a driving transistor M1 that conducts driving current to the organic light emitting diode (OLED). The pixel 100 further includes a first switch M4 transmitting the driving voltage of the organic light emitting diode (OLED) from an anode electrode of the organic light emitting diode (OLED). The first switch M4 receives a sensing signal sense[n] through a sensing line corresponding to a pixel 100 and performs a switching operation in response to the sensing signal sense[n].

In FIG. 2, the sensing signal sense[n] is transferred from the sensing line connected to the pixel 100 included in an n-th pixel row among the plurality of pixels.

The first switch M4 includes a gate electrode connected to the n-th sensing line, a source electrode connected to the anode electrode of the organic light emitting diode (OLED), and a drain electrode connected to a data line Dm.

The pixel 100 further includes a second switch M2 and transmits a data signal data[m] to the driving transistor M1 in response to a scan signal scan[n] from the scan line Sn connected to the pixel 100.

The second switch M2 includes a gate electrode connected to an n-th scan line Sn, a source electrode connected to the corresponding data line Dm to which the data signal is transferred, and a drain electrode connected to the gate electrode of the driving transistor M1.

The pixel 100 further includes a third switch M3 that is connected to the driving transistor M1 and controls the emission of the organic light emitting diode (OLED). The third switch M3 performs the switching operation in response to a light emitting control signal em[n] from the light emitting control line EMn. The third switch M3 includes a gate electrode connected to the light emitting control line EMn, a source electrode connected to a drain electrode of the driving transistor M1, and a drain electrode connected to the anode electrode of the organic light emitting diode (OLED).

The position of the third switch M3 is not limited to the embodiment of FIG. 2, but the third switch may be formed at a position between the first power supply voltage ELVDD and the organic light emitting diode OLED.

The driving transistor M1 includes a gate electrode connected to the drain electrode of the second switch M2, a source electrode connected to the first power supply voltage ELVDD, and a drain electrode connected to the source electrode of the third switch M3.

The anode electrode of the organic light emitting diode (OLED) is connected to the third switch M3 and the cathode electrode is connected to the second power supply voltage ELVSS.

In the exemplary embodiment of FIG. 2, the pixel 100 further includes a capacitor C1 charged by the transferred data voltage. The capacitor C1 includes one terminal connected to the gate electrode of the driving transistor M1 and another terminal connected to the first power supply voltage ELVDD.

The first node N1 is a contact node connected to the driving transistor M1 and the second switch M2.

The organic light emitting diode display can perform external compensation according to the characteristics of the driving transistor M1 and the organic light emitting diode OLED; however, IR drop may be generated in wirings supplying the driving voltage to the pixel 100. In particular, as the size of the display unit 10 is increased, IR drop is a more significant cause of harming the display quality of the display.

In addition, in a large-sized display unit 10, there is a need to perform external compensation in real time in order to improve a response speed.

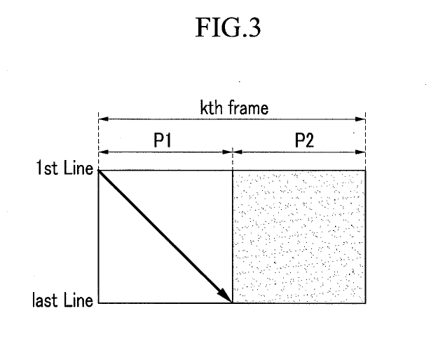

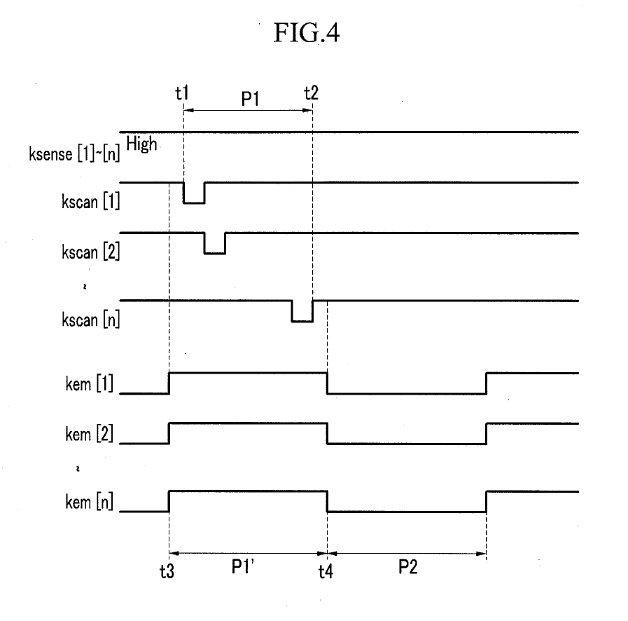

Therefore, the pixel driving methods of FIGS. 3 and 4 according to an exemplary embodiment and the compensation process in the organic light emitting diode display are described in more detail with reference to the driving circuit of the pixel 100 shown in FIG. 2.

FIG. 3 shows method which includes scanning the plurality of pixels in the display unit 10 at a k-th frame, and the organic light emitting diode included in each of the pixels emitting light.

In the method, the drive circuitry scans and selects the plurality of pixels belonging to the display unit 10 in one frame as shown in FIG. 3 from a first line to a final line. During a data writing period P1, the data signal corresponding to the scanned and selected pixels is transmitted to the pixels, and during a light emitting period P2 the data voltage according to the transferred data signals is stored, and each of the organic light emitting diodes included in the pixels emit light according to driving current generated based on the stored data voltage.

The data signal transferred to each of the pixels may be a data signal that is compensated for the ageing of the organic light emitting diode (OLED) or the threshold voltage of the driving transistor M1 and the deviation of the mobility of the driving transistor M1 as described with reference to FIG. 2.

Since each of the organic light emitting diodes included in the pixels emit light during the light emitting period P2 and each of the organic light emitting diodes is maintained at a non-light emitting state for the data writing period P1, during the data writing period P1 current does not flow in the wiring of the driving voltage of the pixels. Accordingly, during the data writing period P1, there is no IR drop.

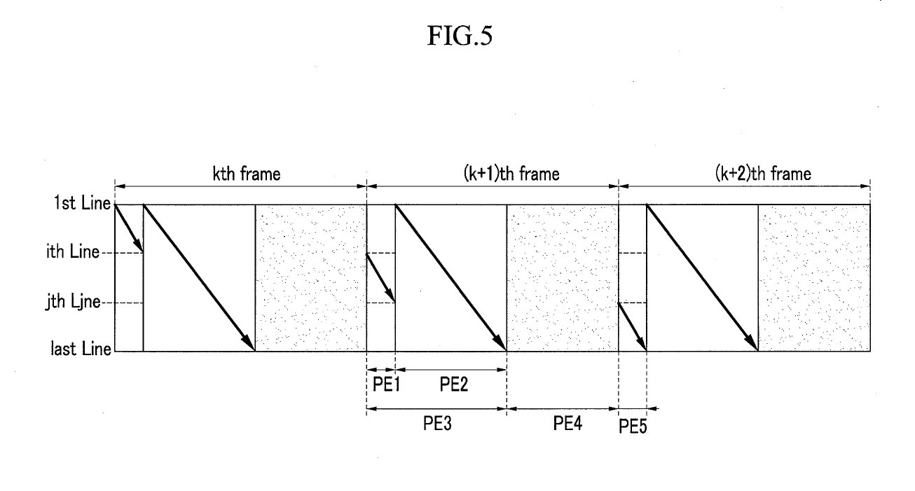

In some embodiments, a sensing period used for compensation may be further included in a k-th frame. The detailed description thereof is described with reference to FIG. 5. The sensing period may selectively not be used in every frame and may have a duration set by the user or the duration may be automatically set.

FIG. 4 is a timing diagram showing timing for a signal driven to a pixel. FIG. 4 shows a driving timing of a k-th frame. According to the exemplary embodiment, the sensing period for performing the external compensation is included in other frames, the sensing signal ksense[1]˜[n] for the k-th frame has the voltage of the gate off level.

In FIG. 2, the transistors included in the pixel are implemented as PMOS transistors, such that the sense signals ksense[1]˜[n] are at a high level as shown in FIG. 4. In this state, the scan signal kscan[1] transmitted through the first scan line transitions to a low state at time t1. When the first scan signal kscan[1] rises to a high state, the scan signal kscan[2] from the second scan line transitions to the low state.

Similarly, the remaining scan signals are sequentially transmitted to the plurality of scan lines as a sequence of low level pulses. The scan signal is sequentially transferred to all the pixels included in the display unit 10 before time t2 when the scan signal kscan[n] transmitted through the n-th scan line transitions to the high level.

The plurality of scan signals are applied to the second switch M2 of each of the plurality of pixels included in the corresponding rows and thus, the second switch M2 of each pixel is turned-on. The corresponding data signal is transmitted through the data line connected to the source electrode of the second switch M2 and the data voltage is applied to the first node N1 according to the data signal. One terminal of the capacitor C1 included in each of the plurality of pixels is connected to the first node N1 such that it stores the data voltages. Since the other terminal of the capacitor C1 is connected to the first power supply voltage ELVDD, the voltage between the gate and source of the driving transistor M1 corresponds to the difference between the voltage of the data signal and the first power supply voltage ELVDD.

As described above, the data voltage corresponding to the data signal is driven to each of the plurality of pixels 100 during period P1.

As can be seen in FIG. 4, the light emitting control signals kem[1]˜[n] are in a high state for period P1′, which overlaps period P1, such that the third switch M3 included in each of the pixels is off. Since the current path is disconnected between the organic light emitting diodes (OLEDs) of the plurality of pixels included in the display unit 10 and the first power supply voltage ELVDD for period P1′, current does not flow to the organic light emitting diode (OLED). Accordingly, the organic light emitting diode does not emit light.

As shown in FIG. 4, the light emitting control signals kem[1]˜[n] transition from a high state to a low state at time t4. Accordingly, the third switch M3 of the pixels are turned on at time t4.

The current corresponding to the data signal voltage stored in each of the pixels flows into the organic light emitting diode (OLED) during period P2 when the light emitting control signals kem[1]˜[n] are maintained in a low state. As a result, the organic light emitting diodes emit light according to the data.

As described above, since the organic light emitting diodes of the pixels are maintained in a non-light emitting state for the data writing period P1, current does not flow in the driving voltage supplying line of the pixels and there is no IR drop in the driving voltage supplying line during the data writing period P1.

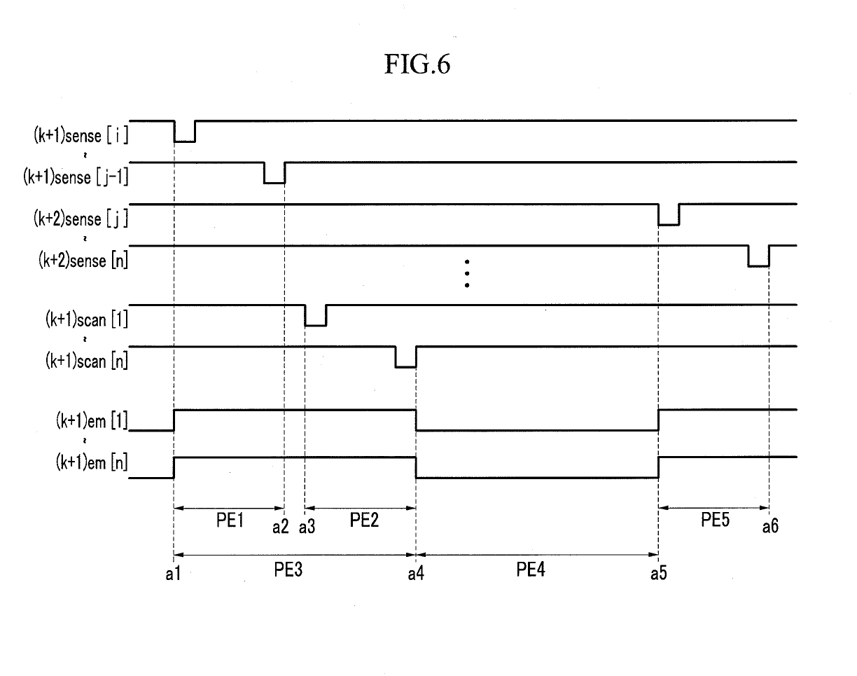

FIGS. 5 and 6 illustrate timing of a driving method according to another exemplary embodiment. In this embodiment, an external compensation period is included in one frame for compensating for the ageing of the organic light emitting diode (OLED) or the threshold voltage and the deviation of the mobility of the driving transistor M1.

Referring to FIG. 5, a k-th frame, a k+1-th frame, and a k+2-th frame are described by way of example. During data writing period PE2 the pixels are charged by sequentially applying voltage according to the data signal to the plurality of pixel rows and during light emitting period PE4 the pixels emit light.

Further, FIG. 5 includes prior to the data writing period PE2, a sensing period PE1 during which the driving voltage of the organic light emitting diode (OLED) is sensed to indicate the degree of ageing of the organic light emitting diode (OLED).

In the exemplary embodiment of FIG. 5 the sensing period PE1 in each frame is prior to the data writing period PE2, but is not limited thereto. For example, the sensing period PE1 may be during another portion of the non-light emitting period PE3. Any of the pixels in the display unit 10 can be sensed for the sensing period. The pixels can be sensed simultaneously in a single group or as shown in FIG. 5, may be grouped into groups of pixel rows. The rows or pixels within a row may be randomly selected.

In the exemplary embodiment of FIG. 5, the pixel rows are divided into three groups and are sensed over a period of three frames. The pixels included in the first pixel row to i−1-th pixel row are sensed in the k-th frame, the pixels included in the i-th pixel row to j−1-th pixel row are sensed in the k+1-th frame. Finally, the pixels included in the j-th pixel row to the n-th pixel row are sensed in the k+2-th frame.

The exemplary embodiment of FIG. 5 uses three groups and three frames, and other embodiments use different numbers of groups and different numbers of frames. In this embodiment, only a subset of the pixels are sensed in one frame for a period and the image displayed in the next frame is compensated based on the sensed information. As a result, the response speed in the large-sized display panel is high, and high image quality with compensated luminance is achieved in real time.

In the exemplary embodiment of FIG. 5, the driving voltage of the organic light emitting diode (OLED) for each of the pixels sensed for the sensing period is transmitted to the compensator 70, which is used to determine the compensation of the data signal for the next frame.

FIG. 6 is a timing diagram showing signals for the pixel shown in FIG. 2 of the k+1-th frame to perform the driving method of FIG. 5. The sensing signal (k+1)sense [i] transmitted to the first switch M4 of pixel 100 transitions from a high state to a low state at time a1. In this case, the pixel 100 is positioned at an i-th pixel row and an m-th pixel column.

Thereafter, the sensing signals are sequentially transmitted to the plurality of sensing lines connected to the i-th pixel row to the j−1-th pixel row.

After sensing signal (k+1)sense[j−1] is transmitted to the first switch M4 of the pixel 100 included in a j−1-th pixel row, the sensing period PE1 ends at timing a2 when the sensing signal (k+1)sense[j−1] rises from the low level to the high level.

Each of the first switches M4 of the pixels in the pixel row to which the sensing signal is transmitted for the sensing period PE1 is turned on and the driving voltage of the organic light emitting diode (OLED) of the pixel is transferred to the data line Dm through the first switch M4.

The second selection switches of the data selector 80 connected to the data lines Dm of the organic light emitting diode display is turned on for the sensing period PE1 and transmit the driving voltage of the organic light emitting diode (OLED) to the compensator 70. The data voltage compensation corresponding to the driving voltage of the organic light emitting diode (OLED) is determined in the compensator 70 in real time.

Referring again to FIG. 6, scan signals are sequentially transferred to the plurality of scan lines connected to the plurality of pixel rows during period PE2 from time a3 to time a4 subsequent to the sensing period PE1.

In response to the scan signals, the second switches M2 of the pixels 100 are sequentially turned on. Accordingly the data signals are sequentially written to each of the pixels, as described above. In this case, the transmitted data signal may be the compensated data signal reflecting the data voltage compensation determined for the sensing period PE1.

The light emitting control signal (k+1)em[1]˜[n] is transmitted to each of the third switches M3 of the pixels in a high level state for the sensing period PE1 and the data writing period PE2, so that the third switches M3 of the pixels are turned off. Therefore, driving current does not flow from the driving transistor M1 to the organic light emitting diode (OLED) during the non-light emitting period PE3, which includes the sensing period PE1 and the data writing period PE2.

As shown in FIG. 6, the non-light emitting period PE3 may start at time a1 of the sensing period PE1 and may end at time a4 of the data writing period PE2, but the non-light emitting period PE3 is not limited thereto and may, for example, be a longer period. At time a4, the light emitting control signals (k+1)em[1]˜[n] transition from the high level to the low level.

The light emitting control signals (k+1)em[1]˜[n] are maintained at the voltage of the low level for the PE4 period from time a4 to time a5. Therefore, the driving current corresponding to the data voltage stored for the data writing period PE2 is conducted to the organic light emitting diode (OLED), such that the organic light emitting diode (OLED) emits light having the luminance corresponding to the driving current for the light emitting period PE4.

A k+2-th frame that is the next frame starts from the time a5 when the light emitting period PE4 of the K+1-th frame ends.

The sensing period PE5 of the k+2-th frame may be positioned at the start of the k+2-th frame. In this case, the driving voltage of the organic light emitting diode (OLED) of the pixels in the pixel row following the pixel row sensed for the sensing period PE1 of the k+1-th frame is sensed. In other words, the sensing signals are sequentially transmitted starting from the sensing signal (k+2)sense[j] for the jth row to the sensing signal (k+2)sense[n] for the nth row.

The driving voltage of the organic light emitting diodes of each of the pixels in the j-th through nth pixel rows are sensed during sensing period PE5 of the k+2-th frame between time a5 and time a6. Thereafter, the data writing period and the light emitting period occur in the k+2-th frame. The driving timing for this period may be the same as that described above for the k+1-th frame.

As shown in FIG. 6, each of the sensing periods in each of a plurality of frames which senses the driving voltage of the organic light emitting diode (OLED) can be reduced, so compensation for the ageing of the organic light emitting diode (OLED) can be performed in real time, thereby making it possible to provide a reliable display device of high quality.

According to another exemplary embodiment, the voltage applied to the gate electrode of the driving transistor M1 of the pixel 100 is sensed. To sense the gate voltage, the scan signal is transmitted to each of the second switches M2 of the pixel 100 during the sensing period. With the gate voltage, it possible to compensate for the characteristics of TFT.

In detail, if the scan signal is transmitted to the second switch M2 of the pixel 100 while the sensing signal is transmitted to the first switch M4 of the pixel 100, and the corresponding data line is connected to the compensator 70 by turning on the selection switch corresponding to each of the pixels 100 in the data selector 80, the voltage applied to the gate electrode of the driving transistor M1 is transferred to the compensator 70 through the data line via the second switch M2.

The compensator 70 uses the transferred voltage to calculate the threshold voltage and the deviation of the mobility of the driving transistor M1 of the plurality of pixels included in the display unit 10 and may determine the compensation of the data signal.

Referring to FIG. 2, the transistors are implemented as PMOS transistors, but this is by way of example only and may be implemented as NMOS transistors. In this case, the voltage levels of the driving signals shown in FIGS. 4 and 6 are inverted to be applied to the pixel configured of the NMOS transistors.

Although various features and aspects are described above with reference to the detailed exemplary embodiments, the description is by way of example only and the present invention is not limited to the specific embodiments discussed.

A person of an ordinary skill in the art may change or modify the described exemplary embodiments without departing from the scope of the present invention and the various changes or modifications are also included in the scope of the present invention. Further, materials of each of the components described are selected or replaced from various materials known to a person of an ordinary skill in the art. In addition, a person of an ordinary skill in the art may omit some of the components described without reducing performance or add components in order to improve performance. Further, a person of an ordinary skill in the art may change the sequence of process steps.

What is claimed is:

1. An organic light emitting diode display, comprising:
a display unit including a plurality of pixels, each pixel including a driving transistor and an organic light emitting diode;
a data driver configured to transmit compensated data signals to each of the pixels;
a scan driver configured to transmit scan signals to each of the pixels;
a sensing driver configured to transmit sensing signals to each of the plurality of pixels;
a light emitting control driver configured to transmit light emitting control signals to each of the pixels; and
a compensator configured to generate the compensated data signals, wherein the data signals are compensated based on a signal corresponding to a degree of ageing of the organic light emitting diode or deviation of the driving transistor from each of the pixels from a group of pixels,
wherein the pixels are configured to emit light according to the compensated data signals.

2. The organic light emitting diode display of claim 1, wherein the group of pixels comprises a plurality of pixels selected by receiving the sensing signal for the sensing period.

3. The organic light emitting diode display of claim 2, wherein the group of pixels comprises a plurality of pixels in a pixel row randomly selected or sequentially selected.

4. The organic light emitting diode display of claim 1, wherein the deterioration degree of the organic light emitting diode is determined by sensing the driving voltage of the organic light emitting diode while current from the driving transistor is supplied to the organic light emitting diode.

5. The organic light emitting diode display of claim 1, wherein each of the pixels includes a first switch with a first electrode that is connected to one electrode of the organic light emitting diode of the pixel, a second electrode that is connected to a data line connected to the pixel, and a gate electrode connected to a sensing line connected to the pixel.

6. The organic light emitting diode display of claim 5, wherein sensing signals are sequentially transmitted to the first switch of each of the pixels.

7. The organic light emitting diode display of claim 1, wherein the deviation of the driving transistor is determined by sensing the gate voltage of the driving transistor while current from the gate electrode of the driving transistor sinks.

8. The organic light emitting diode display of claim 5, wherein:
each of the first switches is turned on in response to a sensing signal, and
wherein each pixel includes a second switch with a first electrode connected to a data line connected to the pixel, a second electrode connected to the driving transistor, and a gate electrode connected to a scan line connected to the pixel, wherein the second switch is turned on in response to a scan signal.

9. The organic light emitting diode display of claim 1, wherein the group of pixels includes all of the pixels of the display.

10. The organic light emitting diode display of claim 1, wherein a plurality of frames include at least one frame including a sensing period during which the driving voltage of the plurality of organic light emitting diodes or the gate electrode voltage of the driving transistor is sensed, a data writing period during which data voltage according to the compensated data signals is written, and a light emitting period during which all the plurality of pixels simultaneously emit light.

11. The organic light emitting diode display of claim 10, wherein the sensing period of the frame does not overlap the light emitting period of the frame.

12. The organic light emitting diode display of claim 10, wherein the scan signals are sequentially transmitted to rows of pixels comprising second transistors and the second transistors are turned on by the scan signals during the data writing period.

13. The organic light emitting diode display of claim 12, wherein the second switches of each pixel include a first electrode connected to a data line connected to the pixel, a second electrode connected to the gate electrode of the driving transistor of the pixel, and a gate electrode connected to a scan line connected to the pixel.

14. The organic light emitting diode display of claim 10, wherein each of the pixels further comprises a third switch, and the third switches are configured to be substantially simultaneously turned on by a light emission control signal on the light emission control line connected thereto during the light emitting period.

15. The organic light emitting diode display of claim 14, wherein the third switch is positioned between the driving transistor and the organic light emitting diode and is configured to conduct current from the driving transistor to the organic light emitting diode.

16. The organic light emitting diode display of claim 14, wherein the third switch includes a first electrode connected to the driving transistor of the pixel, a second electrode connected to the organic light emitting diode of the pixel, and a gate electrode connected to the light emitting control line connected to the pixel.

17. The organic light emitting diode display of claim 1, further comprising:
a data selector including a plurality of first selection switches connected between the data driver and a plurality of data lines connected to the pixels and a plurality of second selection switches connected between a compensator and each of the plurality of data lines,
wherein the second selection switches are turned on during the sensing period so as to transfer the sensed signal to the compensator.

18. The organic light emitting diode display of claim 17, wherein the sensed signal comprises a driving voltage of the organic light emitting diode of a pixel or the gate electrode voltage of the driving transistors of the pixel.

19. The organic light emitting diode display of claim 1, wherein the signal from each pixel is indicative of one or more of ageing of the organic light emitting diode of the pixel, the threshold voltage of the driving transistor of the pixel, and current mobility of the driving transistor of the pixel.

20. A method of driving an organic light emitting diode display including a display unit having a plurality of pixels, a data driver configured to transfer data signals to each of the pixels, a scan driver configured to transfer scan signals to each of the pixels, a sensing driver configured to transfer sensing signals to each of the pixels, a light emitting control driver configured to transfer light emitting control signals to each of the pixels, and a compensator configured to determine data signal compensation for image signals transferred to each of the pixels, the method comprising:
sensing a degree of ageing of the organic light emitting diode of each of the pixels of a group of pixels or sensing deviation of a driving transistor of each pixel of the group;
writing compensated data signal according to a data signal compensated based on the degree of ageing of the organic light emitting diode or the deviation of the driving transistor; and
simultaneously emitting light from the pixels according to the compensated data signal.

21. The method of claim 20, wherein the pixels of the group are selected by receiving the sensing signal for the sensing period.

22. The method of claim 20, wherein sensing the degree of ageing of the organic light emitting diode includes sensing the driving voltage of the organic light emitting diode while current is supplied to the organic light emitting diode.

23. The method of claim 20, wherein the sensing signals are sequentially transmitted to each pixel of the group.

24. The method of claim 20, wherein sensing the deviation of the driving transistor comprises sensing the gate electrode voltage of the driving transistor.

25. The method of claim 24, wherein:
sensing the deviation of the driving transistor comprises turning on a first switch of each pixel with the sensing signal, and turning on a second switch of each pixel with the scan signal.

26. The method of claim 20, wherein the group includes all of the pixels of the display.

27. The method of claim 20, wherein the scan signals are sequentially transmitted to the pixels to write the compensated data signal.

28. The method of claim 20, wherein the light emitting control signals are transmitted to the pixels to cause the pixels to simultaneously emit light.
